(19) United States
(12) Patent Application Publication
(10) Pub. No.: US 2026/0119818 A1
(43) Pub. Date: Apr. 30, 2026

(54) QUESTION GENERATION MODEL TRAINING METHOD, AND ELECTRONIC DEVICE

(71) Applicant: Alipay (Hangzhou) Digital Service Technology Co., Ltd., Hangzhou (CN)

(72) Inventors: Zhenzhe YING, Hangzhou (CN); Lanqing XUE, Hangzhou (CN); Xiaofeng WU, Hangzhou (CN); Weiqiang WANG, Hangzhou (CN)

(21) Appl. No.: 19/431,240

(22) Filed: Dec. 23, 2025

Related U.S. Application Data
(63) Continuation of application No. PCT/CN2024/105123, filed on Jul. 12, 2024.

(30) Foreign Application Priority Data
Jul. 14, 2023 (CN) 202310871334.5

(51) Int. Cl. G06F 40/40; G06F 40/279; G06N 5/02

(52) U.S. Cl. CPC G06F 40/40; G06F 40/279; G06N 5/02

(57) ABSTRACT

A question generation model training method, includes: obtaining a historical complex question, an answer corresponding to the historical complex question, and a historical document-based knowledge base corresponding to the historical complex question, wherein the historical document-based knowledge base includes at least one historical document related to the historical complex question; extracting an entity term related to the historical complex question from the historical document, constructing a simple question based on the entity term, and determining a plurality of historical knowledge points based on the simple question and the historical complex question; and training a question generation model based on the historical document and the plurality of historical knowledge points by using a preset loss function, to obtain a trained question generation model, wherein the question generation model is used to generate a historical complex question corresponding to the historical document.

### CROSS-REFERENCE TO RELATED APPLICATIONS

This application is a continuation application of International Application No. PCT/CN2024/105123, filed July 12, 2024, which claims priority to Chinese Patent Application No. 202310871334.5, filed on July 14, 2023, the entire contents of both of which are incorporated herein by reference.

### TECHNICAL FIELD

The present disclosure relates to the field of intelligent question-answering technologies, and in particular, to a question generation model training method and an electronic device.

### BACKGROUND

Intelligent question-answering is an important form in the human-machine interaction field. An intelligent question-answering system is a new information retrieval system that processes natural languages in a question-and-answer form. A question raised by a user is received, related knowledge in a question-answering database involved in the question is accurately located, and service traversal is performed based on a preset service processing procedure, to implement interaction between a service guide and the user. The related knowledge is fed back to the user as an answer to the question, to complete intelligent question-answering.

Usually, a current intelligent question-answering system can ask only simple questions, for example, questions such as "When were you born?". Such questions do not need relational reasoning and thinking. Because both questions and answers are simple, the simple questions cannot meet user requirements in some fields. For example, when detecting a lie, the user may answer a simple question quickly without an abnormal response. In this case, a user response cannot be observed, and consequently, a lie test effect is inaccurate. Therefore, there is an urgent need to provide a method for generating a complex question that needs relational reasoning and thinking.

According to one aspect, one or more embodiments of this specification provide a question generation model training method, including: obtaining a historical complex question, an answer corresponding to the historical complex question, and a historical document-based knowledge base corresponding to the historical complex question, where the historical document-based knowledge base includes at least one historical document related to the historical complex question; extracting an entity term related to the historical complex question from the historical document, constructing a simple question based on the entity term, and determining a plurality of historical knowledge points based on the simple question and the historical complex question; and training a question generation model based on the historical document and the plurality of historical knowledge points by using a preset loss function, to obtain a trained question generation model, where the question generation model is used to generate a historical complex question corresponding to the historical document.

According to another aspect, one or more embodiments of this specification provide a question generation model training apparatus, including: an input module, configured to obtain a historical complex question, an answer corresponding to the historical complex question, and a historical document-based knowledge base corresponding to the historical complex question, where the historical document-based knowledge base includes at least one historical document related to the historical complex question; a historical knowledge point determining module, configured to: extract an entity term related to the historical complex question from the historical document, construct a simple question based on the entity term, and determine a plurality of historical knowledge points based on the simple question and the historical complex question; and a model training module, configured to train a question generation model based on the historical document and the plurality of historical knowledge points by using a preset loss function, to obtain a trained question generation model, where the question generation model is used to generate a historical complex question corresponding to the historical document.

According to still another aspect, one or more embodiments of this specification provide an electronic device, including: a processor; and a storage, configured to store computer-executable instructions, where the processor is configured to: obtain a historical complex question, an answer corresponding to the historical complex question, and a historical document-based knowledge base corresponding to the historical complex question, where the historical document-based knowledge base includes at least one historical document related to the historical complex question; extract an entity term related to the historical complex question from the historical document, construct a simple question based on the entity term, and determine a plurality of historical knowledge points based on the simple question and the historical complex question; and train a question generation model based on the historical document and the plurality of historical knowledge points by using a preset loss function, to obtain a trained question generation model, where the question generation model is used to generate a historical complex question corresponding to the historical document.

According to yet another aspect, one or more embodiments of this specification provide a non-transitory storage medium. The storage medium stores computer-executable instructions, and when the executable instructions are executed by a processor of an electronic device, the electronic device is caused to perform: obtaining a historical complex question, an answer corresponding to the historical complex question, and a historical document-based knowledge base corresponding to the historical complex question, where the historical document-based knowledge base includes at least one historical document related to the historical complex question; extracting an entity term related to the historical complex question from the historical document, constructing a simple question based on the entity term, and determining a plurality of historical knowledge points based on the simple question and the historical complex question; and training a question generation model based on the historical document and the plurality of historical knowledge points by using a preset loss function, to obtain a trained question generation model, where the question generation model is used to generate a historical complex question corresponding to the historical document.

### BRIEF DESCRIPTION OF DRAWINGS

The following briefly describes the accompanying drawings of this specification. Clearly, the accompanying drawings in the following description merely show example embodiments of this specification.

FIG. 1 is a flowchart illustrating a question generation model training method, according to an embodiment.

FIG. 2 is a schematic diagram illustrating a question generation model training method, according to an embodiment.

FIG. 3 is a flowchart illustrating a question generation model training method, according to an embodiment.

FIG. 4 is a flowchart illustrating a question generation model training method, according to an embodiment.

FIG. 5 is a block diagram illustrating a question generation model training apparatus, according to an embodiment.

FIG. 6 is a block diagram illustrating an electronic device, according to an embodiment.

### DETAILED DESCRIPTION OF EMBODIMENTS

The following describes example embodiments of this specification with reference to the accompanying drawings. Clearly, the described embodiments are merely examples but not all of the embodiments of this specification. All other embodiments obtained by a person of ordinary skill in the art based on one or more embodiments of this specification without making innovative efforts shall fall within the protection scope of this specification.

At present, during educational test question generation and audit examination question generation in the risk control field, to better examine a true level of an answerer, it is usually necessary to design some questions that can be answered only by performing relational reasoning and thinking by the answerer. In a dialogue scenario in which mainly an intelligent robot asks, it is an important research direction to ask a complex question. A common complex question generation manner is, for example, a manner of manually assigning a question library, that is, manually designing and adding a complex question. However, in this manner, a designer needs to read a large amount of related knowledge and then compile the related knowledge into a complex question. After knowledge content is updated, the designer needs to continue to invest to update the complex question. The complex question generated in the above-mentioned manner is highly susceptible to a breakthrough made through repeated attempts by users. In addition, there is an automatic question-answering system AUTOQA, which can generate a simple question. The automatic question-answering system is mainly obtained through training based on a large amount of Internet information. However, for a needed complex question, because there is no enough corpora in the Internet for a complex question scenario, the automatic question-answering system cannot be used for complex question training. Based on this, the embodiments of this specification provide question generation model training methods and apparatuses, to complete model training and reach an available level in a case of samples including a small quantity of complex questions and corresponding answers, thereby greatly improving generation efficiency and a generation effect of complex questions. The following provides detailed descriptions.

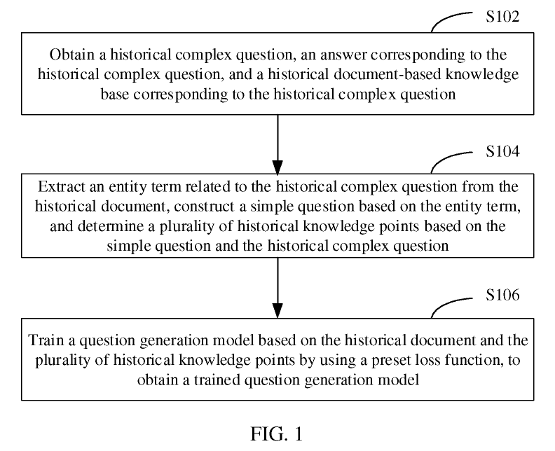

FIG. 1 is a flowchart illustrating a question generation model training method, according to an embodiment. The method can be performed by a terminal device or a server. The terminal device can be a mobile phone, a tablet computer, etc., or can be a computer device such as a notebook computer or a desktop computer. The server can be an independent server, or can be a server cluster including a plurality of servers, etc. The server can be a background server of an application, etc. The method can include the following steps.

Step S102: Obtain a historical complex question, an answer corresponding to the historical complex question, and a historical document-based knowledge base corresponding to the historical complex question, where the historical document-based knowledge base includes at least one historical document related to the historical complex question.

In an embodiment, the historical complex question and the answer corresponding to the historical complex question can be data used for model learning. In this embodiment, the historical complex question and the answer corresponding to the historical complex question can be a pair (namely, historical complex question–answer), or can be a plurality of pairs. During model training, one or more pairs of historical complex questions and answers corresponding to the historical complex questions can be obtained from a specified database as samples, or one or more pairs of historical complex questions and answers corresponding to the historical complex questions can be obtained from a plurality of different users (or data providers) as samples.

The historical complex question in this embodiment, as well as a complex question mentioned below, can be answered only by performing relational reasoning and thinking by an answerer, and a simple question can be directly answered without a need to perform relational reasoning and thinking by an answerer or only by performing simple relational reasoning and thinking.

In an embodiment, the historical complex question (namely, a historical complex question text) or the complex question (namely, a complex question text) can be a question including a multi-hop relationship, can be a question with a constraint, or can be a question that includes a multi-hop relationship and that has a constraint. The complex question including a multi-hop relationship is, for example, "Who is the director of the movie starring A?". The question can be answered only through a multi-hop reasoning path including a plurality of triples such as a triplet "A, starring, new XX story" and "new XX story, director, B". It can be inferred that "B" is an answer corresponding to the complex question. The complex question with a constraint is, for example, "Who won the men's singles title at the first Wimbledon?". "First" in this question represents a constraint on an answer entity. In actual applications, A is replaced with a name of a specific movie star, and B is replaced with a name of a specific director.

The simple question can often include a single relationship, for example, "When were you born?", which can be a simple question, but "What important things happened in the year you were born" can be a complex question.

The historical document-based knowledge base in this embodiment corresponds to the historical complex question. That is, an answer to the historical complex question can be found in the historical document-based knowledge base. During implementation, one historical complex question may correspond to one historical document related to the historical complex question, or one historical complex question may correspond to two or more related historical documents. This is not limited in this embodiment of this specification.

In an implementation, the historical document-based knowledge base is an open-source updatable knowledge base. For example, the knowledge base can be obtained via the Internet, and an updated historical document-based knowledge base is obtained as Internet information is updated.

Step S104: Extract an entity term related to the historical complex question from the historical document, construct a simple question based on the entity term, and determine a plurality of historical knowledge points based on the simple question and the historical complex question.

The historical document corresponding to the historical complex question can include a plurality of entity terms. The entity term related to the historical complex question can be extracted from the historical document, and a corresponding simple question can be constructed based on each entity term, or a corresponding simple question can be constructed based on a plurality of entity terms in the historical document, to form one or more simple questions related to the historical complex question. In this embodiment of this specification, the entity term related to the historical complex question is extracted from the historical document, and then a simple question corresponding to the entity term is constructed, to greatly reduce a simple question unrelated to the historical complex question, thereby improving model training efficiency and saving resources.

In an implementation, the simple question can be manually set based on the entity term and expert experience, or the simple question corresponding to the entity term can be automatically generated by using an intelligent question-answering system. This is not limited in this embodiment.

It can be learned from step S104 that after the simple question is constructed based on the entity term, the plurality of historical knowledge points are determined based on the simple question and the historical complex question. In an implementation, each simple question can be compared with the historical complex question, to determine the plurality of historical knowledge points; or the historical complex question can be compared with each simple question one by one based on a preset keyword, to determine the plurality of historical knowledge points; or a similarity between each simple question and the historical complex question can be obtained through comparison, and one or more entity terms with a high similarity can be used as historical knowledge point.

In an embodiment, a quantity of the plurality of historical knowledge points determined based on the simple question and the historical complex question is set based on a complex question of a user requirement. In an implementation, there are two or three historical knowledge points. Correspondingly, after a question generation model is completed, when the question generation model is used to generate a complex question, there can be two or three knowledge points. The quantity of knowledge points can enable the generated complex question or historical complex question to meet a user question asking requirement without being too complex or occupying too many resources.

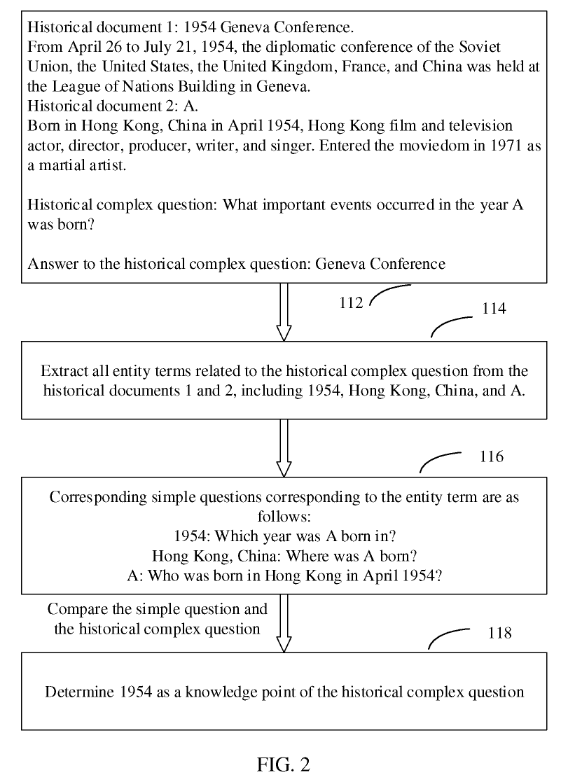

FIG. 2 is a schematic diagram illustrating a question generation model training method, according to an embodiment. For example, the historical document-based knowledge base includes two historical documents. A specific historical document, a specific historical complex question, and an answer corresponding to the specific historical complex question are shown in FIG. 2 as follows:

Historical document 1: 1954 Geneva Conference.

### From April 26 to July 21, 1954, the diplomatic conference of the Soviet Union, the United States, the United Kingdom, France, and China was held at the League of Nations Building in Geneva.

### Historical document 2: A.

### Born in Hong Kong, China in April 1954, Hong Kong film and television actor, director, producer, writer, and singer. Entered the moviedom in 1971 as a martial artist.

### Historical complex question: What important events occurred in the year A was born?

### Answer to the historical complex question: Geneva Conference.

For the historical complex question "What important events occurred in the year A was born?", for two knowledge points "Which year was A born in" and "What important events occurred in 1954?" corresponding to the historical complex question, related information needs to be found in the corresponding historical document 1 and the corresponding historical document 2. To determine the two knowledge points, entity terms related to the historical complex question in the two historical documents can be extracted (114), and corresponding simple questions are constructed for the entity terms (116). These entity terms include 1954, Hong Kong, China, A, etc. A constructed simple question can be, for example, a simple question "Which year was A born in" corresponding to the entity term "1954", a simple question "Where was A born" corresponding to the entity term "Hong Kong, China", or a simple question "Who was born in Hong Kong on April 7, 1954" corresponding to the entity term "A". Finally, the simple question is compared with the historical complex question, to determine that the entity term "1954" is most likely an examination point of the historical complex question, and can be used as a historical knowledge point (118). The entity term "A" exists in the historical complex question, and cannot be used as a historical knowledge point. The entity term "Hong Kong, China" has little connection with historical complex question, and cannot be used as a historical knowledge point.

Step S106: Train a question generation model based on the historical document and the plurality of historical knowledge points by using a preset loss function, to obtain a trained question generation model, where the question generation model is used to generate a historical complex question corresponding to the historical document.

In an implementation, after the plurality of corresponding historical knowledge points are determined for each historical complex question, controllable generation training can be performed based on a controllable generation prompt learning mechanism, by using the historical document corresponding to the historical complex question and the plurality of historical knowledge points as input data, by using the historical complex question as an output result, and based on a preset loss function, until the preset loss function converges, or a preset quantity of iterations is reached, to obtain the question generation model.

A text controllable generation manner is used in the controllable generation prompt learning mechanism, and the text controllable generation manner is generating a corresponding text by using a model for some prompt-based controllable elements in the input data. The prompt-based controllable element in this embodiment is the historical document corresponding to the historical complex question and the plurality of historical knowledge points, and an output text is the historical complex question.

A question generation model generated in a text controllable generation manner can be a pre-trained language model. The question generation model can be any one of a generative pre-training (GPT) model, a denoising sequence-to-sequence pre-training for natural language generation, translation, and comprehension (BART) model, or a transfer text-to-text transformer (T5) model. This is not limited in this embodiment.

The preset loss function can be a cross-entropy loss function (CE-loss), a focal-loss function (focal-loss), etc. An objective to be achieved based on the preset loss function can be that a historical complex question generated by the question generation model is enabled to be infinitely close to a historical complex question used as a label.

In an implementation, the preset loss function can be a cross-entropy loss function. The loss function is applied more conveniently, which helps improve model training precision and training efficiency.

In the embodiment, the historical complex question, the answer corresponding to the historical complex question, and the historical document-based knowledge base corresponding to the historical complex question are obtained. The entity term related to the historical complex question is extracted from the historical document, the simple question is constructed based on the entity term, and the plurality of historical knowledge points are determined based on the simple question and the historical complex question. The question generation model is trained based on the historical document and the plurality of historical knowledge points by using the preset loss function, to obtain the trained question generation model. Automatic generation of the historical complex question is completed by extracting the plurality of historical knowledge points from the historical document. The extracted knowledge point is based on the entity term related to the historical complex question, and the historical knowledge point is finally determined based on the simple question and the historical complex question that are constructed based on the entity term. The generated historical complex question is more specific by extracting the historical knowledge point, and the knowledge point is examined more accurately, thereby improving model training efficiency and improving accuracy of generating the complex question by a model. In addition, the trained question generation model can generate the complex question intelligently. In addition, the plurality of knowledge points can be selected as examination points for examination, thereby effectively reducing manpower and improving question generation efficiency. In addition, the generated complex question is not a simple question that can be directly found via the Internet. Therefore, a risk of a breakthrough made through credential stuffing can be greatly reduced, and the generated complex question is more stable. Each complex question can correspond to at least two knowledge points, and also correspond to at least two simple questions, which is equivalent to decomposing one complex question into two simple questions, so that the model training method is more explanatory. In addition, compared with a training method of AUTOQA, in the question generation model training method in this embodiment of the specification, only samples of complex questions that account for 10% and answers corresponding to the complex questions need to be used as reference for training. Usually, a model obtained through training based on approximately 100 complex questions and answers corresponding to the complex questions can reach an available level. There is no need for a large quantity of samples, thereby reducing resources, and further helping improving model training efficiency.

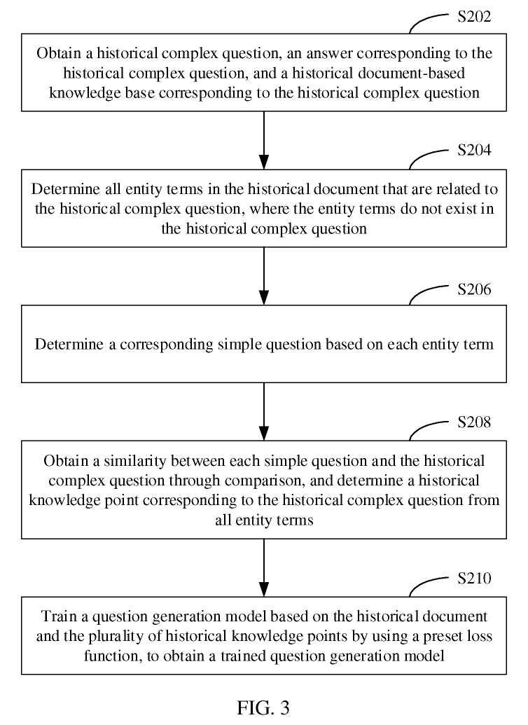

FIG. 3 is a flowchart illustrating a question generation model training method, according to an embodiment. As shown in FIG. 3, the method can include the following steps.

S202: Obtain a historical complex question, an answer corresponding to the historical complex question, and a historical document-based knowledge base corresponding to the historical complex question, where the historical document-based knowledge base includes at least one historical document related to the historical complex question.

For Step S202, reference can be made to the above embodiments, and details are not repeated herein for simplicity.

S204: Determine an entity term that is in the historical document and that is related to the historical complex question, where the entity term does not exist in the historical complex question.

If the entity term exists in the historical complex question, the entity term may not be used as a knowledge point (or referred to as an examination point). Based on this, the entity term can be removed from the entity term that is in the historical document and that is related to the historical complex question. After the entity term is removed in step S204, a corresponding simple question is no longer generated in subsequent step S206, and a quantity of simple questions compared with the historical complex question is reduced in S208, thereby saving resources and improving model training efficiency.

S206: Determine a corresponding simple question based on each entity term, where the simple question is a question including a single relationship.

In an implementation, the simple question is generated by using AUTOQA. For example, the simple question corresponding to each entity term is generated based on an automatic question-answering system by using each entity term as an answer.

S208: Obtain a similarity between each simple question and the historical complex question through comparison, and determine a historical knowledge point corresponding to the historical complex question from all entity terms.

It can be learned from steps S204 to S208 that, when the entity term is extracted, the simple question is constructed based on the entity term, and a plurality of historical knowledge points are determined based on the simple question and the historical complex question, in this embodiment, the historical knowledge point is extracted by obtaining the similarity through comparison. In such a method in which an overlapping degree between the simple question and the complex question is obtained through comparison, the historical knowledge point is found through unsupervised comparison, which helps more accurately obtain the similarity between each simple question and the historical complex question through comparison, so that the determined historical knowledge point is more accurate, thereby improving accuracy of generating the complex question by using a trained model.

In an implementation, for the obtaining a similarity between each simple question and the historical complex question through comparison, and determining a historical knowledge point corresponding to the historical complex question from all entity terms, steps A1 and A2 can be performed:

Step A1: Calculate a bilingual evaluation understudy (BLEU) value between each simple question and the historical complex question, to obtain the similarity between the simple question and the historical complex question.

Step A2: Determine, based on the similarity obtained through calculation, the plurality of historical knowledge points corresponding to the historical complex question from the determined the entity term based on a preset similarity threshold.

In an implementation, an answer to a simple question corresponding to a similarity higher than a preset similarity threshold can be used as a historical knowledge point based on the preset similarity threshold. For example, when the BLEU value exceeds a preset BLEU threshold, it is determined that an entity term corresponding to the simple question is a knowledge point corresponding to the historical complex question; otherwise, it is determined that an entity term corresponding to the simple question is not a knowledge point corresponding to the historical complex question.

Obtained similarities can be sorted in descending order of similarities, and answers to the first n (n is a positive integer greater than or equal to 1) simple questions in a sorted sequence can be used as historical knowledge points.

In an implementation, for the obtaining a similarity between each simple question and the historical complex question through comparison, and determining a historical knowledge point corresponding to the historical complex question from the determined entity term, steps B1 and B2 can be performed:

Step B1: Calculate a length of a longest common substring between each simple question and the historical complex question, to obtain the similarity between each simple question and the historical complex question.

Step B2: Determine, based on the similarity obtained through calculation, the plurality of historical knowledge points corresponding to the historical complex question from all the entity terms based on a preset similarity threshold.

A principle of steps B1 and B2 is the same as that of steps A1 and A2. Details are not repeated herein for simplicity.

S210: Train a question generation model based on the historical document and the plurality of historical knowledge points by using a preset loss function, to obtain a trained question generation model, where the question generation model is used to generate a historical complex question corresponding to the historical document.

For step S210, reference can be made to the above embodiments, and details are not repeated herein for simplicity.

In the embodiment, after the historical complex question, the answer corresponding to the historical complex question, and the historical document-based knowledge base corresponding to the historical complex question are obtained, all the entity terms in the historical document that are related to the historical complex question are determined. The entity term does not exist in the historical complex question. The corresponding simple question is determined based on each entity term. The similarity between each simple question and the historical complex question is obtained through comparison, and the historical knowledge point corresponding to the historical complex question is determined from all the entity terms. Finally, the question generation model is trained based on the historical document and the plurality of historical knowledge points by using a preset loss function, to obtain a trained question generation model. Because it is set that an entity term needs to meet a condition of "not existing in the historical complex question", unnecessary entity terms can be removed, and unnecessary simple question generation and comparison operations can be reduced, thereby saving resources, and improving model training efficiency. In this embodiment of this specification, the historical knowledge point is determined by obtaining the similarity between each simple question and the historical complex question through comparison, and the historical knowledge point is found through unsupervised comparison. This helps more accurately obtain the similarity between each simple question and the historical complex question through comparison, so that the determined historical knowledge point is more accurate, thereby improving accuracy of generating the complex question by using the trained model.

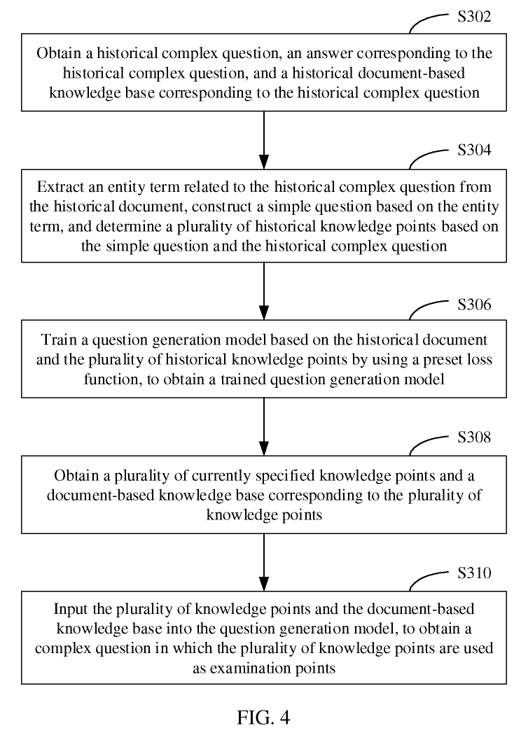

FIG. 4 is a flowchart illustrating a question generation model training method, according to an embodiment. As shown in FIG. 4, the method can include the following steps.

S302: Obtain a historical complex question, an answer corresponding to the historical complex question, and a historical document-based knowledge base corresponding to the historical complex question, where the historical document-based knowledge base includes at least one historical document related to the historical complex question.

S304: Extract an entity term related to the historical complex question from the historical document, construct a simple question based on the entity term, and determine a plurality of historical knowledge points based on the simple question and the historical complex question.

For example, after the entity term is extracted and the simple question is constructed based on the entity term, each simple question can be manually compared with the historical complex question, to determine the plurality of historical knowledge points. The historical complex question can alternatively be compared with each simple question one by one based on a preset keyword, to determine the plurality of historical knowledge points. One or more entity terms with a high similarity can alternatively be used as historical knowledge points by obtaining the similarity between each simple question and the historical complex question.

In an implementation, for the extracting an entity term related to the historical complex question from the historical document, constructing a simple question based on the entity term, and determining a plurality of historical knowledge points based on the simple question and the historical complex question, steps C1 to C3 can be performed:

Step C1: Determine all entity terms in the historical document that are related to the historical complex question, where the entity terms do not exist in the historical complex question.

Step C2: Determine a corresponding simple question based on each entity term, where the simple question is a question including a single relationship.

Step C3: Obtain a similarity between each simple question and the historical complex question through comparison, and determine a historical knowledge point corresponding to the historical complex question from all the entity terms.

S306: Train a question generation model based on the historical document and the plurality of historical knowledge points by using a preset loss function, to obtain a trained question generation model, where the question generation model is used to generate a historical complex question corresponding to the historical document.

S308: Obtain a plurality of currently specified knowledge points and a document-based knowledge base corresponding to the plurality of knowledge points.

After the question generation model is obtained through model training, when the model is used to generate the complex question, input data is the knowledge point and the related document-based knowledge base. The document-based knowledge base includes at least one document related to a to-be-examined knowledge point, which can be specifically an open-source document, or can be a document prepared by a user. The knowledge point can be specified by the user based on a requirement. In a possible implementation, two or three knowledge points can be specified for a historical complex question.

S310: Input the plurality of knowledge points and the document-based knowledge base into the question generation model, to obtain a complex question in which the plurality of knowledge points are used as examination points.

For Step 302 to Step 306, reference can be made to the above embodiments, and details are not repeated herein for simplicity.

In the embodiment, the historical complex question, the answer corresponding to the historical complex question, and the historical document-based knowledge base corresponding to the historical complex question are obtained; the entity term related to the historical complex question is extracted from the historical document, the simple question is constructed based on the entity term, and the plurality of historical knowledge points are determined based on the simple question and the historical complex question; and the question generation model is trained based on the historical document and the plurality of historical knowledge points by using the preset loss function, to obtain the trained question generation model. After training model is completed, the plurality of currently specified knowledge points and the document-based knowledge base corresponding to the plurality of knowledge points are obtained, and the plurality of knowledge points and the document-based knowledge base are into the question generation model, to obtain the complex question in which the plurality of knowledge points are used as examination points. In this way, the complex question is generated. In this embodiment of the specification, the question generation model is trained, and then the complex question is generated by using the question generation model. When the question generation model is trained, automatic generation of the historical complex question is completed by extracting the plurality of historical knowledge points from the historical document. The extracted knowledge point is based on the entity term related to the historical complex question, and the historical knowledge point is finally determined based on the simple question and the historical complex question that are constructed based on the entity term. The generated historical complex question is more specific by extracting the historical knowledge point, and the knowledge point is examined more accurately, thereby improving model training efficiency and improving accuracy of generating the complex question by a model. Compared with a training method of AUTOQA, in the question generation model training method in this embodiment of the specification, only samples of complex questions that account for 10% and questions corresponding to the complex questions need to be used as reference for training. Usually, a model obtained through training based on approximately 100 complex questions and answers corresponding to the complex questions can reach an available level. There is no need for a large quantity of samples, thereby reducing resources, and further helping improving model training efficiency. In addition, the trained question generation model can generate the complex question intelligently. In addition, the plurality of knowledge points can be selected as examination points for examination, thereby effectively reducing manpower and improving question generation efficiency. In addition, the generated complex question is not a simple question that can be directly found via the Internet. Therefore, a risk of a breakthrough made through credential stuffing can be greatly reduced, and the generated complex question is more stable. Each complex question can correspond to at least two knowledge points, and also correspond to at least two simple questions, which is equivalent to decomposing one complex question into two simple questions, so that the model training method is more explanatory.

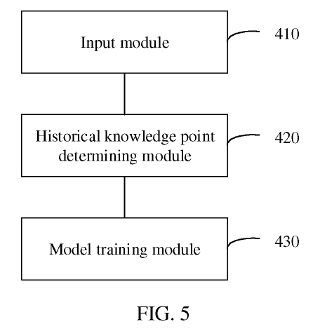

FIG. 5 is a block diagram illustrating a question generation model training apparatus, according to an embodiment. As shown in FIG. 5, the question generation model training apparatus includes an input module 410, a historical knowledge point determining module 420, and a model training module 430. The input module 410 is configured to obtain a historical complex question, an answer corresponding to the historical complex question, and a historical document-based knowledge base corresponding to the historical complex question. The historical document-based knowledge base includes at least one historical document related to the historical complex question. The historical knowledge point determining module 420 is configured to: extract an entity term related to the historical complex question from the historical document, construct a simple question based on the entity term, and determine a plurality of historical knowledge points based on the simple question and the historical complex question. The model training module 430 is configured to train a question generation model based on the historical document and the plurality of historical knowledge points by using a preset loss function, to obtain a trained question generation model. The question generation model is used to generate a historical complex question corresponding to the historical document.

In an embodiment, the historical knowledge point determining module 420 includes: an entity term determining unit, configured to determine all entity terms in the historical document that are related to the historical complex question, where the entity terms do not exist in the historical complex question; a simple question construction unit, configured to determine a corresponding simple question based on each entity term, where the simple question is a question including a single relationship; and a similarity comparison unit, configured to obtain a similarity between each simple question and the historical complex question through comparison, and determine a historical knowledge point corresponding to the historical complex question from all the entity terms.

In an implementation, the simple question construction unit is configured to generate the simple question corresponding to each entity term based on an automatic question-answering system by using each entity term as an answer.

In an implementation, the similarity comparison unit includes: a similarity calculation subunit, configured to calculate a BLEU value between each simple question and the historical complex question or calculate a length of a longest common substring between each simple question and the historical complex question, to obtain a similarity between each simple question and the historical complex question; and a similarity-based historical knowledge point extraction subunit, configured to determine, based on the similarity obtained through calculation, the plurality of historical knowledge points corresponding to the historical complex question from all the entity terms based on a preset similarity threshold.

In an embodiment, the historical complex question includes a multi-hop relationship and/or a question with a constraint, or a question that includes a multi-hop relationship and that has a constraint.

In an implementation, the historical document-based knowledge base in the input module 410 is an open-source updatable knowledge base.

In an implementation, there are two or three historical knowledge points corresponding to the historical complex question in the historical knowledge point determining module 420.

In an implementation, a preset loss function in the model training module 430 is a cross-entropy loss function.

In an embodiment, the question generation model training apparatus further includes: an information obtaining module, configured to obtain a plurality of currently specified knowledge points and a document-based knowledge base corresponding to the plurality of knowledge points; and a complex question generation module, configured to input the plurality of knowledge points and the document-based knowledge base into the question generation model, to obtain a complex question in which the plurality of knowledge points are used as examination points.

It can be understood by those skilled in the art that the foregoing question generation model training apparatus can be used to implement the above-mentioned question generation model training method, and detailed descriptions of the question generation model training apparatus need to be similar to those of the method part. Details are not repeated herein for simplicity.

In the above embodiments, the historical complex question, the answer corresponding to the historical complex question, and the historical document-based knowledge base corresponding to the historical complex question are obtained by using the input module. The entity term related to the historical complex question is extracted from the historical document by using the historical knowledge point determining module, the simple question is constructed based on the entity term, and the plurality of historical knowledge points are determined based on the simple question and the historical complex question. The question generation model is trained based on the historical document and the plurality of historical knowledge points by using the preset loss function by using the model training module, to obtain the trained question generation model. Automatic generation of the historical complex question is completed by extracting the plurality of historical knowledge points from the historical document. The extracted knowledge point is based on the entity term related to the historical complex question, and the historical knowledge point is finally determined based on the simple question and the historical complex question that are constructed based on the entity term. The generated historical complex question is more specific by extracting the historical knowledge point, and the knowledge point is examined more accurately, thereby improving model training efficiency and improving accuracy of generating the complex question by a model. In addition, the trained question generation model can generate the complex question intelligently. In addition, the plurality of knowledge points can be selected as examination points for examination, thereby effectively reducing manpower and improving question generation efficiency. In addition, the generated complex question is not a simple question that can be directly found via the Internet. Therefore, a risk of a breakthrough made through credential stuffing can be greatly reduced, and the generated complex question is more stable. Each complex question can correspond to at least two knowledge points, and also corresponds to at least two simple questions, which is equivalent to decomposing one complex question into two simple questions, so that the model training method is more explanatory. In addition, compared with a training method of AUTOQA, in the question generation model training method in this embodiment of the specification, only samples of complex questions that account for 10% and questions corresponding to the complex questions need to be used as reference for training. Usually, a model obtained through training based on approximately 100 complex questions and answers corresponding to the complex questions can reach an available level. There is no need for a large quantity of samples, thereby reducing resources, and further helping improving model training efficiency.

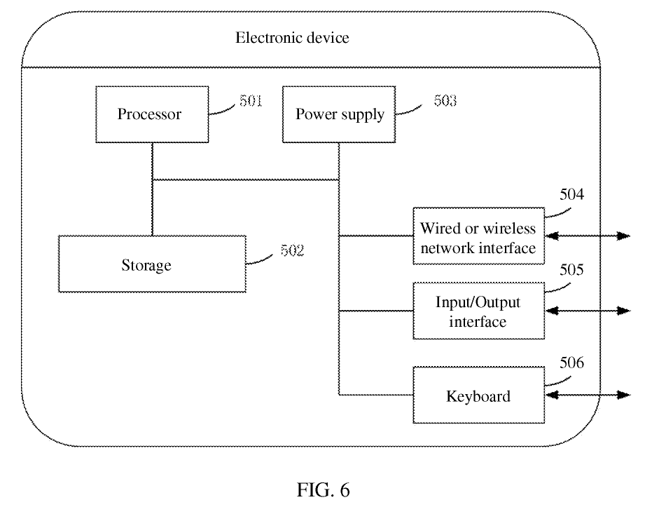

FIG. 6 is a block diagram illustrating an electronic device, according to an embodiment. The electronic device can vary greatly due to a configuration or performance difference, and can include one or more processors 501 and a storage 502. The storage 502 can store one or more storage applications or data. The storage 502 can be a temporary storage or a persistent storage. The application stored in the storage 502 can include one or more modules (not shown in the figure), and each module can include a series of computer-executable instructions in the electronic device. Still further, the processor 501 can be configured to communicate with the storage 502 to execute a series of computer-executable instructions in the storage 502 on the electronic device. The electronic device can further include one or more power supplies 503, one or more wired or wireless network interfaces 504, one or more input/output interfaces 505, one or more keyboards 506, etc. The storage 502 can include a non-persistent memory, a random access memory (RAM), a non-volatile memory, and/or another form that are in a computer-readable medium, for example, a read-only memory (ROM) or a flash memory (flash RAM).

For example, the electronic device includes a storage and one or more programs. The one or more programs are stored in the storage. The one or more programs can include one or more modules. Each module can include a series of computer-executable instructions in the electronic device. The one or more processors are configured to execute the following computer-executable instructions included in the one or more programs: obtaining a historical complex question, an answer corresponding to the historical complex question, and a historical document-based knowledge base corresponding to the historical complex question, where the historical document-based knowledge base includes at least one historical document related to the historical complex question; extracting an entity term related to the historical complex question from the historical document, constructing a simple question based on the entity term, and determining a plurality of historical knowledge points based on the simple question and the historical complex question; and training a question generation model based on the historical document and the plurality of historical knowledge points by using a preset loss function, to obtain a trained question generation model, where the question generation model is used to generate a historical complex question corresponding to the historical document.

In the embodiment, the historical complex question, the answer corresponding to the historical complex question, and the historical document-based knowledge base corresponding to the historical complex question are obtained. The entity term related to the historical complex question is extracted from the historical document, the simple question is constructed based on the entity term, and the plurality of historical knowledge points are determined based on the simple question and the historical complex question. The question generation model is trained based on the historical document and the plurality of historical knowledge points by using the preset loss function, to obtain the trained question generation model. Automatic generation of the historical complex question is completed by extracting the plurality of historical knowledge points from the historical document. The extracted knowledge point is based on the entity term related to the historical complex question, and the historical knowledge point is finally determined based on the simple question and the historical complex question that are constructed based on the entity term. The generated historical complex question is more specific by extracting the historical knowledge point, and the knowledge point is examined more accurately, thereby improving model training efficiency and improving accuracy of generating the complex question by a model. In addition, the trained question generation model can generate the complex question intelligently. In addition, the plurality of knowledge points can be selected as examination points for examination, thereby effectively reducing manpower and improving question generation efficiency. In addition, the generated complex question is not a simple question that can be directly found via the Internet. Therefore, a risk of a breakthrough made through credential stuffing can be greatly reduced, and the generated complex question is more stable. Each complex question can correspond to at least two knowledge points, and also correspond to at least two simple questions, which is equivalent to decomposing one complex question into two simple questions, so that the model training method is more explanatory. In addition, compared with a training method of AUTOQA, in the question generation model training method in this embodiment of the specification, only samples of complex questions that account for 10% and questions corresponding to the complex questions need to be used as reference for training. Usually, a model obtained through training based on approximately 100 complex questions and answers corresponding to the complex questions can reach an available level. There is no need for a large quantity of samples, thereby reducing resources, and further helping improving model training efficiency.

Further, based on the above methods shown in FIGS. 1 to 4, embodiments of this specification further provide a storage medium, configured to store computer-executable instructions. In an embodiment, the storage medium can be a USB flash drive, an optical disc, a hard disk, etc. When computer-executable instruction information stored in the storage medium is executed by a processor, the following procedure can be implemented: obtaining a historical complex question, an answer corresponding to the historical complex question, and a historical document-based knowledge base corresponding to the historical complex question, where the historical document-based knowledge base includes at least one historical document related to the historical complex question; extracting an entity term related to the historical complex question from the historical document, constructing a simple question based on the entity term, and determining a plurality of historical knowledge points based on the simple question and the historical complex question; and training a question generation model based on the historical document and the plurality of historical knowledge points by using a preset loss function, to obtain a trained question generation model, where the question generation model is used to generate a historical complex question corresponding to the historical document.

In the embodiment, the historical complex question, the answer corresponding to the historical complex question, and the historical document-based knowledge base corresponding to the historical complex question are obtained. The entity term related to the historical complex question is extracted from the historical document, the simple question is constructed based on the entity term, and the plurality of historical knowledge points are determined based on the simple question and the historical complex question. The question generation model is trained based on the historical document and the plurality of historical knowledge points by using the preset loss function, to obtain the trained question generation model. Automatic generation of the historical complex question is completed by extracting the plurality of historical knowledge points from the historical document. The extracted knowledge point is based on the entity term related to the historical complex question, and the historical knowledge point is finally determined based on the simple question and the historical complex question that are constructed based on the entity term. The generated historical complex question is more specific by extracting the historical knowledge point, and the knowledge point is examined more accurately, thereby improving model training efficiency and improving accuracy of generating the complex question by a model. In addition, the trained question generation model can generate the complex question intelligently. In addition, the plurality of knowledge points can be selected as examination points for examination, thereby effectively reducing manpower and improving question generation efficiency. In addition, the generated complex question is not a simple question that can be directly found via the Internet. Therefore, a risk of a breakthrough made through credential stuffing can be greatly reduced, and the generated complex question is more stable. Each complex question can correspond to at least two knowledge points, and also correspond to at least two simple questions, which is equivalent to decomposing one complex question into two simple questions, so that the model training method is more explanatory. In addition, compared with a training method of AUTOQA, in the question generation model training method in this embodiment of the specification, only samples of complex questions that account for 10% and questions corresponding to the complex questions need to be used as reference for training. Usually, a model obtained through training based on approximately 100 complex questions and answers corresponding to the complex questions can reach an available level. There is no need for a large quantity of samples, thereby reducing resources, and further helping improving model training efficiency.

Example embodiments of this specification are described above. Other embodiments fall within the scope of the appended claims. In some cases, steps in the claims can be performed in a different order than described in the embodiments, and desired results can still be achieved. In addition, processes depicted in the accompanying drawings do not necessarily require the particular order or sequential order shown to achieve the desired results. In some embodiments, multi-task processing and parallel processing can be advantageous.

Apparatuses, modules, or units that are set forth in the above implementations can be embodied by a computer chip or an entity or by a product with a specific function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above apparatus is divided into modules based on functions for separate description. Each module can be implemented in one or more pieces of software and/or hardware.

A person skilled in the art should understand that one or more embodiments of this specification can be provided as methods, systems, or computer program products. Therefore, one or more embodiments of this specification can be a form of hardware only embodiments, software only embodiments, or embodiments with a combination of software and hardware. Moreover, the one or more embodiments of this specification can use the form of a computer program product implemented on one or more computer available storage media (including, but not limited to, disk storage, CD-ROM, optical memory, etc.), where the computer available program code is included.

One or more embodiments of this specification are described with reference to the flowcharts and/or block diagrams of the method, the device (system), and the computer program product based on the embodiments of this specification. It should be understood that computer program instructions may be used to implement each process and/or each block in the flowcharts and/or the block diagrams and a combination of a process and/or a block in the flowcharts and/or the block diagrams. These computer program instructions can be provided for a general-purpose computer, a special-purpose computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

These computer program instructions can alternatively be stored in a computer-readable storage that can instruct the computer or the another programmable data processing device to work in a specific way, so the instructions stored in the computer-readable storage generate an artifact that includes an instruction apparatus. The instruction apparatus implements a specific function in one or more procedures in the flowcharts and/or in one or more blocks in the block diagrams.

These computer program instructions can alternatively be loaded onto the computer or the another programmable data processing device, so that a series of operation steps are performed on the computer or the another programmable device, thereby generating computer-implemented processing. Therefore, the instructions executed on the computer or the another programmable device provide steps for implementing a specific function in one or more procedures in the flowcharts and/or in one or more blocks in the block diagrams.

Computer-readable media, including permanent and non-permanent, removable and non-removable media, can be implemented by any method or technology for information storage. The information can be computer-readable instructions, a data structure, a program module, or other data. Examples of a storage medium of a computer include, but are not limited to, a phase-change memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a read-only memory (CD-ROM), a digital versatile disk (DVD) or another optical storage, a magnetic cassette tape, a magnetic tape storage or another magnetic device, or any other non-transmission medium, and can be configured to store information accessible to a computing device. As specified in this specification, the computer-readable medium does not include transitory computer-readable media (transitory media), such as a modulated data signal and carrier.

It is worthwhile to further note that the terms "include", "comprise", or any other variant thereof are intended to cover a non-exclusive inclusion, so that a process, a method, or a device that includes a list of elements not only includes those elements but also includes other elements which are not expressly listed, or further includes elements inherent to such a process, method, or device. Without more constraints, an element preceded by "includes a …" does not preclude the existence of additional identical elements in the process, method, product, or device that includes the element.

In some embodiments, the above method can be implemented with a computer executable instruction executed by a computer, for example, a program module. Generally, the program module includes a routine, a program, an object, a component, a data structure, etc. for executing a specific task or implementing a specific abstract data type. This specification can alternatively be practiced in distributed computing environments. In the distributed computing environments, tasks are performed by remote processing devices connected through a communication network. In a distributed computing environment, the program module can be located in both local and remote computer storage media including storage devices.

The embodiments of this specification are described in a progressive method. For same or similar parts in the embodiments, references can be made to each other.

The above descriptions are merely example embodiments of this specification and are not intended for limiting this specification. Any modifications, equivalent replacements, and improvements made within the spirit and principle of this specification shall fall within the scope of the claims of this specification.

1. A question generation model training method, comprising:
obtaining a historical complex question, an answer corresponding to the historical complex question, and a historical document-based knowledge base corresponding to the historical complex question, wherein the historical document-based knowledge base comprises at least one historical document related to the historical complex question;
extracting an entity term related to the historical complex question from the historical document, constructing a simple question based on the entity term, and determining a plurality of historical knowledge points based on the simple question and the historical complex question; and
training a question generation model based on the historical document and the plurality of historical knowledge points by using a preset loss function, to obtain a trained question generation model, wherein the question generation model is used to generate a historical complex question corresponding to the historical document.

2. The method according to claim 1, wherein the extracting the entity term related to the historical complex question from the historical document, constructing the simple question based on the entity term, and determining the plurality of historical knowledge points based on the simple question and the historical complex question comprises:
determining all entity terms in the historical document that are related to the historical complex question, wherein the entity terms do not exist in the historical complex question;
determining a corresponding simple question based on each entity term, wherein the simple question is a question comprising a single relationship; and
obtaining a similarity between each simple question and the historical complex question through comparison, and determining a historical knowledge point corresponding to the historical complex question from all the entity terms.

3. The method according to claim 2, wherein the determining the corresponding simple question based on each entity term comprises:
generating the simple question corresponding to each entity term based on an automatic question-answering system by using each entity term as an answer.

4. The method according to claim 2, wherein the obtaining the similarity between each simple question and the historical complex question through comparison, and determining the historical knowledge point corresponding to the historical complex question from all the entity terms comprises:
calculating a BLEU value between each simple question and the historical complex question or calculating a length of a longest common substring between each simple question and the historical complex question, to obtain a similarity between each simple question and the historical complex question; and
determining, based on the similarity obtained through calculation, the plurality of historical knowledge points corresponding to the historical complex question from all the entity terms based on a preset similarity threshold.

5. The method according to claim 1, wherein a quantity of the plurality of historical knowledge points corresponding to the historical complex question is two or three.

6. The method according to claim 1, wherein the historical complex question comprises a question comprising at least one of a multi-hop relationship or a question with a constraint.

7. The method according to claim 1, wherein the preset loss function is a cross-entropy loss function.

8. The method according to claim 1, further comprising:
obtaining a plurality of currently specified knowledge points and a document-based knowledge base corresponding to the plurality of knowledge points; and
inputting the plurality of knowledge points and the document-based knowledge base into the question generation model, to obtain a complex question in which the plurality of knowledge points are used as examination points.

9. An electronic device, comprising:
a processor; and
a storage, configured to store computer-executable instructions,
wherein the processor is configured to:
obtain a historical complex question, an answer corresponding to the historical complex question, and a historical document-based knowledge base corresponding to the historical complex question, wherein the historical document-based knowledge base comprises at least one historical document related to the historical complex question;
extract an entity term related to the historical complex question from the historical document, construct a simple question based on the entity term, and determine a plurality of historical knowledge points based on the simple question and the historical complex question; and
train a question generation model based on the historical document and the plurality of historical knowledge points by using a preset loss function, to obtain a trained question generation model, wherein the question generation model is used to generate a historical complex question corresponding to the historical document.

10. The electronic device according to claim 9, wherein the processor is further configured to:
determine all entity terms in the historical document that are related to the historical complex question, wherein the entity terms do not exist in the historical complex question;
determine a corresponding simple question based on each entity term, wherein the simple question is a question comprising a single relationship; and
obtain a similarity between each simple question and the historical complex question through comparison, and determine a historical knowledge point corresponding to the historical complex question from all the entity terms.

11. The electronic device according to claim 10, wherein the processor is further configured to:
generate the simple question corresponding to each entity term based on an automatic question-answering system by using each entity term as an answer.

12. The electronic device according to claim 10, wherein the processor is further configured to:
calculating a BLEU value between each simple question and the historical complex question or calculating a length of a longest common substring between each simple question and the historical complex question, to obtain a similarity between each simple question and the historical complex question; and
determining, based on the similarity obtained through calculation, the plurality of historical knowledge points corresponding to the historical complex question from all the entity terms based on a preset similarity threshold.

13. The electronic device according to claim 9, wherein a quantity of the plurality of historical knowledge points corresponding to the historical complex question is two or three.

14. The electronic device according to claim 9, wherein the historical complex question comprises a question comprising at least one of a multi-hop relationship or a question with a constraint.

15. The electronic device according to claim 9, wherein the preset loss function is a cross-entropy loss function.

16. The electronic device according to claim 9, wherein the processor is further configured to:
obtain a plurality of currently specified knowledge points and a document-based knowledge base corresponding to the plurality of knowledge points; and
input the plurality of knowledge points and the document-based knowledge base into the question generation model, to obtain a complex question in which the plurality of knowledge points are used as examination points.

17. A non-transitory computer-readable storage medium storing instructions that, when executed by a processor of an electronic device, cause the electronic device to perform a question generation model training method, the method comprising:
obtaining a historical complex question, an answer corresponding to the historical complex question, and a historical document-based knowledge base corresponding to the historical complex question, wherein the historical document-based knowledge base comprises at least one historical document related to the historical complex question;
extracting an entity term related to the historical complex question from the historical document, constructing a simple question based on the entity term, and determining a plurality of historical knowledge points based on the simple question and the historical complex question; and
training a question generation model based on the historical document and the plurality of historical knowledge points by using a preset loss function, to obtain a trained question generation model, wherein the question generation model is used to generate a historical complex question corresponding to the historical document.
